(19) United States
(12) Patent Application Publication
(10) Pub. No.: US 2014/0060927 A1
(43) Pub. Date: Mar. 6, 2014

(54) HOOK-THREAD COMPONENT AND WIRING ELEMENT FASTENING DEVICE HAVING THE HOOK-THREAD COMPONENT

(71) Applicant: Teh-Tsung CHIU, New Taipei City (TW)

(72) Inventor: Teh-Tsung CHIU, New Taipei City (TW)

(73) Assignee: AVC INDUSTRIAL CORP.

(21) Appl. No.: 13/598,849

(22) Filed: Aug. 30, 2012

(51) Int. Cl. H02G 15/02

(52) U.S. Cl. 174/75 R

(57) ABSTRACT

A wiring element fastening device is provided to fasten a wiring element to a wiring element connector. The wiring element connector includes an engaging part that is electrically engageable with a terminal of the wiring element. The wiring element fastening device includes: a hook-thread component having a base part engaged with the wiring element connector and a screwing part integrated with the base part; and a fastening element for fastening a wiring member of the wiring element and screwed with the screwing part. With the above-described structure, the terminal of the wiring element will not be in poor contact with or separated from the engaging part of the wiring element connector, even if one end of the wiring element is pulled by an external force or a corresponding end of the wiring element connector is pulled.

### BACKGROUND OF THE INVENTION

1. Field of the Invention

This invention relates to wiring element fastening devices, and, more particularly, to a hook-thread component and a wiring element fastening device having the hook-thread component.

2. Description of Related Art

UK Patent No. 2363007, entitled “CABLE FASTENER,” discloses a cable connector of a junction box, including a casing, a lock nut, a clamping part, a collar, and a chuck.

The casing allows a cable to pass a hollow piping member in the casing, and has a block disposed on a middle segment of the casing. A wire incoming end and a wire outgoing end extends in two opposite directions from two ends of the casing divided by the block. The clamping part is integrated with a tail part of the wire outgoing end. The collar clips the cable, and can be received in and hooked and positioned by the clamping part. The chuck can lock the a wire outgoing end of the casing, and clip and prop against the clamping part and the collar along an axial direction, to drive the clamping part the and collar to clip a periphery of the cable, to as to achieve water-proof, anti-dust, anti-electromagnetic waves, and anti-pulling effects.

However, the cable has at least the following problems. Since the clamping part is integrated on the casing, the casing is very long and thus it is inconvenient for a user to, with his finger, to plug/pull a male connector into/from a female connector installed in the cable box. Besides, the cable is fastened to the cable box via an engaging force between the male connector and the female connector only. Therefore, the male connector is easily separated from or in poor contact with the female connector as the cable is pulled by an external force.

Therefore, a novel wiring element fastening device is required to be brought into to market to solve the problems of the prior art.

### SUMMARY OF THE INVENTION

In order to overcome the above problem, it is an objective of the present invention to provide a wiring element fastening device, in order to ensure that the terminal of the wiring element will not be in poor contact with or separated from the wiring element connector, even if the terminal of the wiring element or the corresponding terminal of the wiring element connector are pulled by an external force.

In order to achieve the objective, the present invention provides a wiring element fastening device for fastening a wiring element to a wiring element connector having an engaging part that is electrically engageable with a terminal of the wiring element, the wiring element fastening device comprising: a hook-thread component including a base part engageable with the wiring element connector and a screwing part engageable with the base part, the screwing part and the base part have inner portions in communication; and a fastening element for fastening a wiring member of the wiring element and being screwed with the screwing part.

Preferably, the base part has a receiving part for receiving the wiring element connector, and a wedging groove part disposed inside the receiving part, and the wiring element connector has a wedging part disposed on an outer surface thereof for hooking with the wedging groove part when the wiring element connector is received in the receiving part.

Preferably, the fastening element includes an engaging element, and the engaging element has a casing, an engagement through hole, a front screwing part, and a rear screwing part.

Preferably, the clamping claw further includes a clamping claw seam.

Preferably, the chucking lock nut includes a chucking lock nut through hole, an inner thread, and a tapered inside wall.

Preferably, the fastening element further includes a clamping ring, and the clamping ring has a clamping ring through hole, a groove, and a clamping ring seam.

Preferably, the wiring element fastening device is further engaged with and fastened to a board element. The board element has a through hole. The front screwing part of the engaging element of the fastening element passes the through hole of the board element that is stationary and screwed with the screwing part of the hook-thread component, and the base part of the hook-thread component can thus be hooked to the wiring element connector.

The present invention further provides a hook-thread component, including a base part wedged with a wiring element connector and having a receiving part for receiving the wiring element connector and a wedging groove part disposed inside the receiving part, wherein the wiring element connector has an engaging part electrically engageable with a terminal of a wiring element, and a wedging part disposed on an outer surface thereof and wedged with the wedging groove part when the wiring element connector is received in the receiving part; and a screwing part that is screwed with a fastening element that is used for fastening a wiring member of the wiring element, wherein the screwing part is engaged with the base part, and the screwing part and the base part have inner portions in communication.

The present invention has at least the following advantages.

Since the hook-thread component of the wiring element fastening device according to the present invention can be hooked to the wiring element connector, the front screwing part of the engaging element of the fastening element can pass the through hole of the stationary board element and screwed with the screwing part of the hook-thread component, and the fastening element can thus clamp the wiring member of the wiring element, the terminal of the wiring element will not be in poor contact with or separated from the engaging part of the wiring element connector, even if one end of the wiring element and the corresponding end of the wiring element connector are pulled by an external force. Besides, since the front screwing part of the engaging element of the fastening element of the wiring element fastening device can be screwed with the screwing part of the hook-thread component, the screwed the fastening element and the hook-thread component are not too long such that a user is allowed to, with his finger, electrically engage the terminal in the wiring element with the engaging part of the wiring element connector.

### BRIEF DESCRIPTION OF DRAWINGS

The invention can be more fully understood by reading the following detailed description of the preferred embodiments, with reference made to the accompanying drawings, wherein:

FIG. 1 is an exploded diagram of a wiring element fastening device of an embodiment according to the present invention;

FIGS. 2A-2F are side and front views of components contained in the wiring element fastening device, respectively; and

FIG. 2G is an assembly diagram of the wiring element fastening device.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

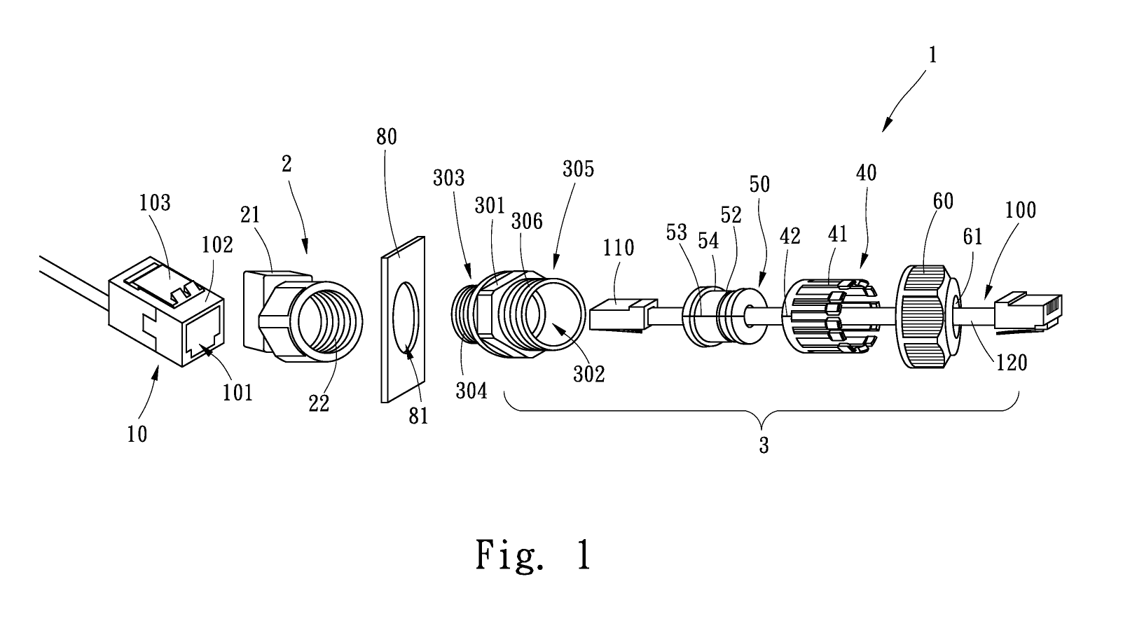

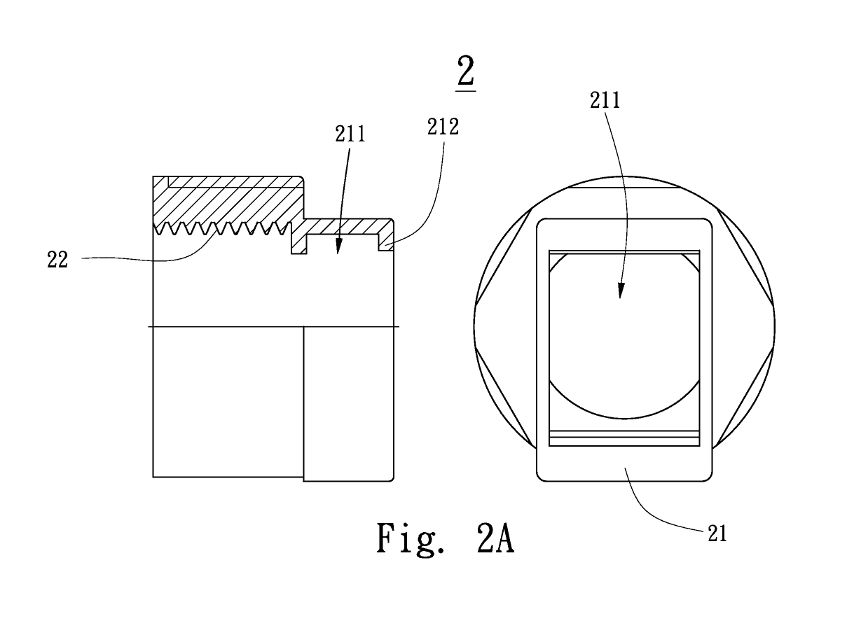

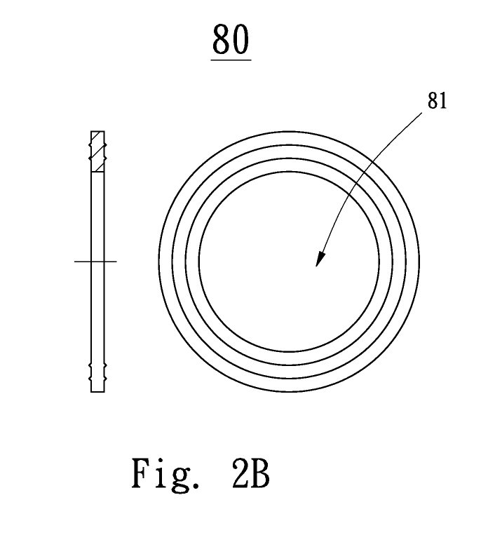

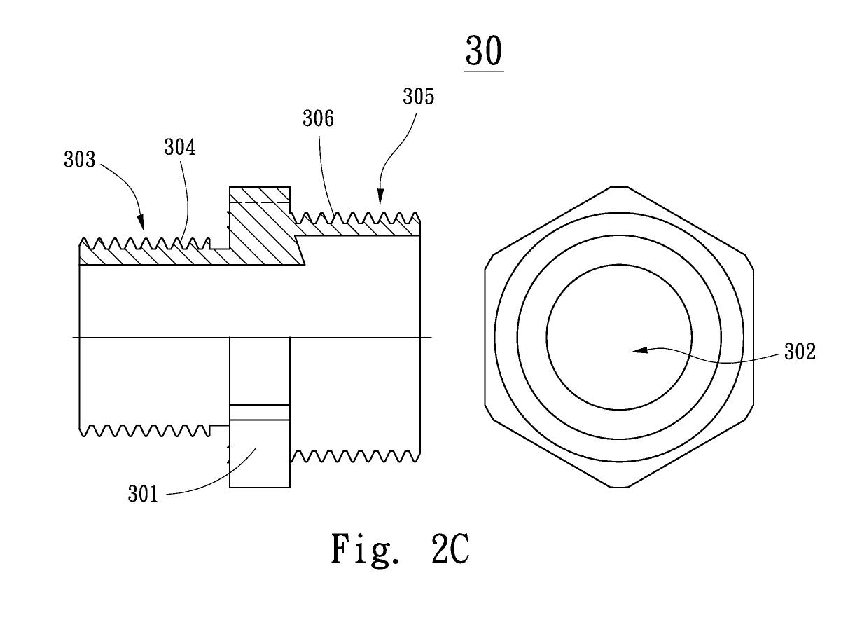

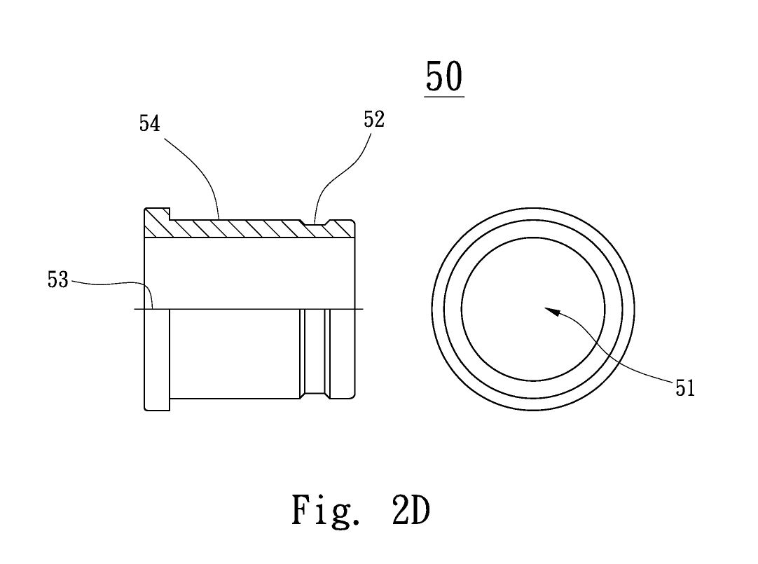

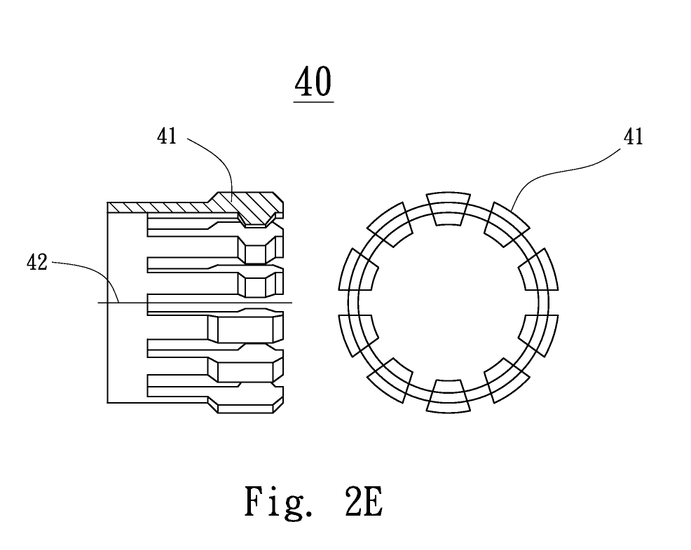

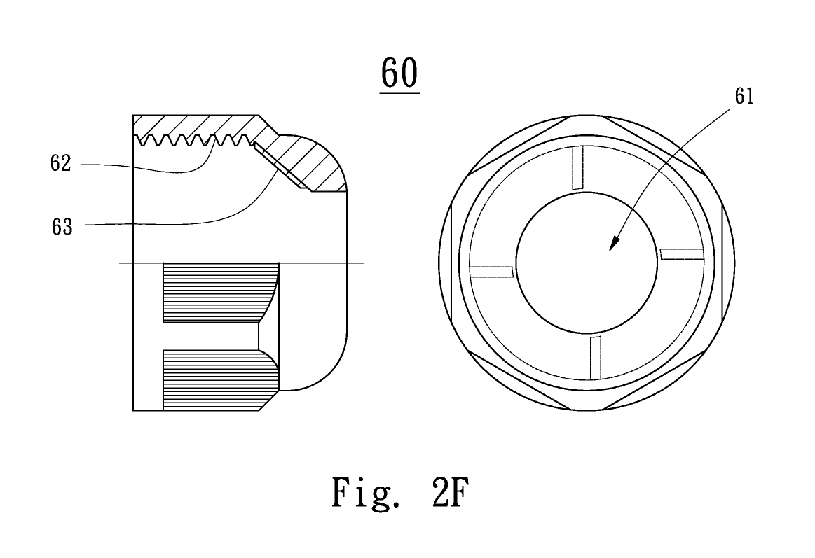

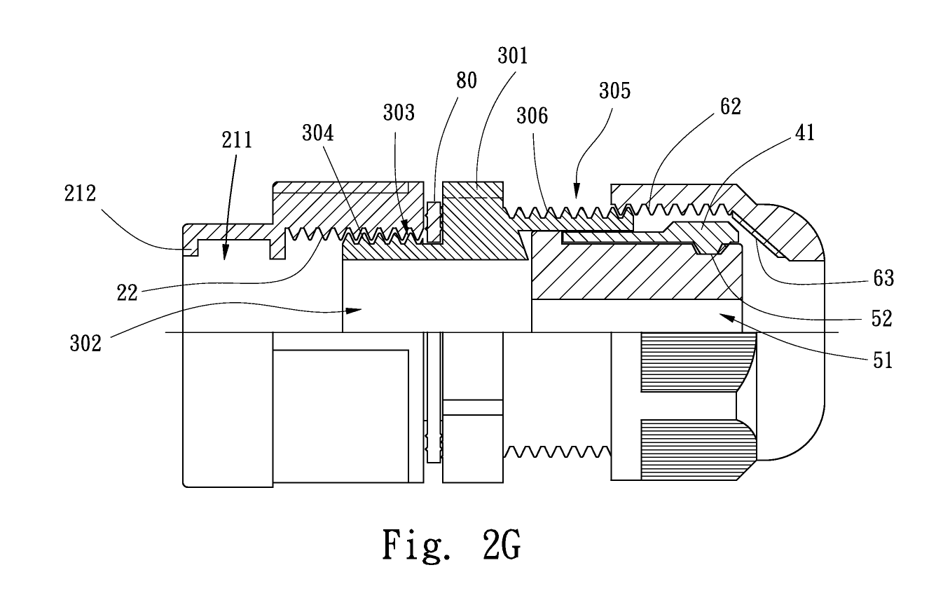

Please refer to FIGS. 1 and 2A-2G, wherein FIG. 1 is an exploded view of a wiring element fastening device 1 of an embodiment according to the present invention, FIGS. 2A-2F are side and front view of components contained in the wiring element fastening device 1, respectively, and FIG. 2G is an assembly view of the wiring element fastening device 1. The wiring element fastening device 1 is used for fastening a wiring element 100 (e.g., a telephone line, a cable, or an optical fiber) to a wiring element connector 10. The wiring element connector 10 has an engaging part 101 that is electrically engageable with a terminal 110 of the wiring element 100.

Please also refer to FIG. 2A. The wiring element fastening device 1 comprises a hook-thread component 2 and a fastening element 3. In an embodiment of the present invention, the hook-thread component 2 includes a base part 21 and a screwing part 22. The base part 21 can be engaged with the wiring element connector 10. The screwing part 22 can be engaged with the base part 21, and the screwing part 22 and the base part 21 have inner portions in communication, allowing the wiring element 100 to pass therethrough. In an embodiment, the screwing part 22 is integrated with the base part 21, and the fastening element 3 can fasten a wiring member 120 of the wiring element 100 and screwed with the screwing part 22. In an embodiment, the fastening element 3 clamps the wiring member 120.

In an embodiment of the present invention, the base part 21 has a receiving part 212 for receiving the wiring element connector 10, and a wedging groove part 212 disposed inside the receiving part 211. The wiring element connector 10 has a wedging part 103 disposed on an outer surface 102 thereof for being wedged in the wedging groove part 212 when the wiring element connector 10 is received in the receiving part 211.

In an embodiment of the present invention, the fastening element 3 comprises an engaging element 30, a clamping claw 40, a clamping ring 50, and a chucking lock nut 60.

Please refer to FIGS. 2C to 2F at the same time. In an embodiment of the present invention, the engaging element 30 includes a casing 301, an engagement through hole 302 penetrating the casing 301, a front screwing part 304 disposed on a front end 303 of the engagement through hole 302, and a rear screwing part 306 disposed on a rear end 305 of the engagement through hole 302. The wiring member 120 of the wiring element 100 can pass the engagement through hole 302, and the front screwing part 304 can be screwed with the screwing part 22 of the hook-thread component 2. In an embodiment, the front screwing part 304 is an outer thread, and the screwing part 22 has an inner thread that can be screwed with the outer thread.

In an embodiment of the present invention, the clamping claw 40 has a plurality of spaced-apart hook parts 41. The clamping claw 40 can get stuck in the engagement through hole 302 of the engaging element 30. The clamping claw 40 further comprises a clamping claw seam 42 that cuts a wall of the clamping claw 40 along an axial direction and is in communication with a space defined by the hook parts 41. The clamping claw seam 42 allows the clamping claw 40 to be pulled apart and clamp a periphery of the clamping ring 50.

In an embodiment of the present invention, the clamping ring 50 can be received in the clamping claw 40 and a space defined by the hook parts 41. The clamping ring 50 comprises: a clamping ring through hole 51 for clamping the wiring member 120 of the wiring element 100; a groove 52 formed on an outer surface 54 of the clamping ring 50; and a clamping ring seam 53 that cuts a wall of the clamping ring 50 along an axial direction and is in communication with the clamping ring through hole 51. The clamping claw 40 clamps a periphery of the clamping ring 50, and the hook parts 41 can be hooked in the groove 52. When the wiring member 120 of the wiring element 100 is clamped in the clamping ring through hole 51 of the clamping ring 50, since the clamping ring 50 is tightly received in the space defined by the clamping claw 40 and the hook parts 41 and the groove 52 is hooked by the hook parts 41 and tightly presses the wiring member 120, moisture and dust will not enter in a board element 80 (e.g., a board of an electrical box, a wall, a board for connection and fastening, and a fastening board of a machine) along the wiring member 120.

In an embodiment of the present invention, the chucking lock nut 60 can be screwed with the rear screwing part 306 of the engaging element 30 (please refer to FIGS. 2C and 2F at the same time). The chucking lock nut 60 comprises a chucking lock nut through hole 61, an inner thread 62 formed inside the chucking lock nut through hole 61, and a tapered inside wall 63 connected between the inner thread 62 and the chucking lock nut through hole 61. The inner thread 62 can be screwed with the rear screwing part 306 of the engaging element 30. The tapered inside wall 63 can gradually chucks the hook parts 41 of the clamping claw 40 when the clamping claw 40 gets stuck in the engagement through hole 302 of the engaging element 30 and the inner thread 62 is screwed with rear screwing part 306 of the engaging element 30.

In an embodiment of the present invention, the wiring element fastening device 1 is further engaged with and fastened to a board element 80 (please refer to FIGS. 2B and 2G at the same time). The board element 80 has a through hole 81. The front screwing part 304 of the engaging element 30 of the fastening element 3 can pass through the through hole 81 of the board element 80 that is stationary, and screwed with the screwing part 22 of the hook-thread component 2, and the base part 21 of the hook-thread component 2 can be hooked to the wiring element connector 10. Therefore, the fastening element 3 fastens the wiring member 120 of the wiring element 100. Even if one terminal of the wiring element 100 or the corresponding end of the wiring element connector 10 is pulled by an external force, the terminal of the wiring element 100 will not be in poor contact with or separated from the engaging part 101 of the wiring element connector 10.

In an embodiment, the board element 80 is a board of an electrical box, a wall, a board for connection and fastening, or a fastening board of a machine.

Since the hook-thread component 2 of the wiring element fastening device 1 according to the present invention can be hooked to the wiring element connector 10, the front screwing part 304 of the engaging element 30 of the fastening element 3 can pass the through hole 81 of the stationary board element 80 and screwed with the screwing part 22 of the hook-thread component 2, and the fastening element 3 can thus clamp the wiring member 120 of the wiring element 100, the terminal 110 of the wiring element 100 will not be in poor contact with or separated from the engaging part 101 of the wiring element connector 10, even if one end of the wiring element 120 and the corresponding end of the wiring element connector 10 are pulled by an external force.

Accordingly, the present invention, since having a particular water-proof and great-tension design and performing an anti-loose and chucking function, can achieve the IP68 function. Besides, since the front screwing part 304 of the engaging element 30 of the fastening element 3 of the wiring element fastening device 1 can be screwed with the screwing part 22 of the hook-thread component 2, the screwed the fastening element 3 and the hook-thread component 2 are not too long such that a user is allowed to, with his finger, electrically engage the terminal 110 in the wiring element 100 with the engaging part 101 of the wiring element connector 10.

The wiring element fastening device 1 of the present invention can be applied to a network, connector, telecommunication or communication, LED lighting, monitor, solar communication wiring, audio/video equipment, digital display, traffic sign, and detection and measurement instrument, and can provide outdoor protection to incoming and outgoing line connector of any equipment. Therefore, the present invention provides an improved network line socket technique that provides water-proof and great tension functions.

In the embodiment shown in FIGS. 1 and 2, the reference numeral “80” denotes a board element. However, in another embodiment of the present invention, the reference numeral “80” may denote a case body or a fixed block (foundation plate) that cooperates with the above-mentioned techniques. Accordingly, the wiring element 100 can thus be fastened to a hole of a metal box via the wiring element fastening device 1 of the present invention.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A wiring element fastening device for fastening a wiring element to a wiring element connector having an engaging part that is electrically engageable with a terminal of the wiring element, the wiring element fastening device comprising:
a hook-thread component including a base part engageable with the wiring element connector and a screwing part engageable with the base part, the screwing part and the base part have inner portions in communication; and
a fastening element for fastening a wiring member of the wiring element and being screwed with the screwing part.

2. The wiring element fastening device of claim 1, wherein the base part has a receiving part for receiving the wiring element connector, and a wedging groove part disposed inside the receiving part, and the wiring element connector has a wedging part disposed on an outer surface thereof for being wedged with the wedging groove part when the wiring element connector is received in the receiving part.

3. The wiring element fastening device of claim 1, wherein the fastening element comprises:
an engaging element including a casing, an engagement through hole penetrating the casing, a front screwing part disposed on a front end of the engagement through hole, and a rear screwing part disposed on a rear end of the engagement through hole, wherein the wiring member of the wiring element passes the engagement through hole, and the front screwing part is screwed with the screwing part of the hook-thread component;
a clamping claw including a plurality of spaced-apart hook parts, the clamping claw getting stuck in the engagement through hole of the engaging element;
a chucking lock nut screwed with the rear screwing part of the engaging element.

4. The wiring element fastening device of claim 3, wherein the fastening element further comprises a clamping ring received in a space defined by the clamping claw and the hook parts, the clamping ring having a clamping ring through hole for clamping the wiring member of the wiring element.

5. The wiring element fastening device of claim 4, wherein the clamping ring further comprises a groove disposed on an outer surface thereof, and the hook parts of the clamping claw are hooked in the groove.

6. The wiring element fastening device of claim 4, wherein the clamping ring further comprises a clamping ring seam that cuts a wall of the clamping ring along an axial direction and communicates with the clamping ring through hole.

7. The wiring element fastening device of claim 3, wherein the chucking lock nut comprises a chucking lock nut through hole, an inner thread formed inside the chucking lock nut through hole, and a tapered inside wall connected between the inner thread and the chucking lock nut through hole, the inner thread is screwed with the rear screwing part of the engaging element, and the tapered inside wall gradually chucks the hook parts of the clamping claw when the clamping claw gets stuck in the engagement through hole of the engaging element and the inner thread is screwed with the rear screwing part of the engaging element.

8. The wiring element fastening device of claim 3, wherein the clamping claw further comprises a clamping claw seam that cuts a wall of the clamping claw along an axial direction, allowing the clamping claw to be pulled apart and the clamping ring to be easily received in the clamping claw and in communication with a space defined by the hook parts.

9. The wiring element fastening device of claim 3, wherein the wiring element fastening device is further engaged with and fastened to a board element having a through hole, the front screwing part of the engaging element of the fastening element passes the through hole of the board element and screws with the screwing part of the hook-thread component, and the base part of the hook-thread component is wedged to the wiring element connector.

10. A hook-thread component, comprising:
a base part wedged with a wiring element connector and having a receiving part for receiving the wiring element connector and a wedging groove part disposed inside the receiving part, wherein the wiring element connector has an engaging part electrically engageable with a terminal of a wiring element, and a wedging part disposed on an outer surface thereof and wedged with the wedging groove part when the wiring element connector is received in the receiving part; and
a screwing part that is screwed with a fastening element that is used for fastening a wiring member of the wiring element, wherein the screwing part is engaged with the base part, and the screwing part and the base part have inner portions in communication.

11. The hook-thread component of claim 10, wherein the screwing part is integrated with the base part.
